(19) United States
(12) Patent Application Publication
(10) Pub. No.: US 2012/0221950 A1
(43) Pub. Date: Aug. 30, 2012

(54) GESTURE MANIPULATION METHOD AND MULTIMEDIA PLAYER APPARATUS

(75) Inventors: Chia-Chen CHAO, TAIPEI HSIEN (TW); Wen-Kang CHEN, TAIPEI HSIEN (TW)

(73) Assignee: AVERMEDIA TECHNOLOGIES, INC., NEW TAIPEI CITY (TW)

(21) Appl. No.: 13/152,298

(22) Filed: Jun. 3, 2011

(30) Foreign Application Priority Data
Feb. 24, 2011 (TW) 100106246

(51) Int. Cl. G06F 3/048

(52) U.S. Cl. 715/716

(57) ABSTRACT

A gesture manipulation method and a multimedia player apparatus is disclosed in this disclosure. The gesture manipulation method is suitable for a multimedia player apparatus with touch input function. The gesture manipulation method includes steps of: detecting a gesture input while the multimedia player apparatus is playing a video file or a video stream; and, when the gesture input includes a specific amount of finger contacts and the finger contacts relatively move in a specific pattern, executing a corresponding function on the multimedia player apparatus. Accordingly, the user interface of the multimedia player apparatus adopting some intuitive gestures can be easy to understand.

### RELATED APPLICATIONS

This application claims priority to Taiwan Application Serial Number 100106246, filed Feb. 24, 2011, which is herein incorporated by reference.

### BACKGROUND

1. Field of Invention

The present invention relates to an interface operation method. More particularly, the present invention relates to an operation method based on hand gestures and the apparatus thereof.

2. Description of Related Art

Recently, the touch input device becomes one of popular products among all Consumer Electronics on rocketing market. Various kinds of electronic products (e.g. personal computers, smart household electronics and handheld devices) with touch input function are introduced to consumers. The touch input interface can be used to replace the traditional input interface, such as keyboard, mouse, or trackball, or can be used to cooperate with the traditional input interface for forming a new input interface with more operational options.

Nowadays the touch input interface is disposed on most multimedia players, such as notebook computers, tablet computers, smart phones, handheld video players, touch screen, smart DVD players, etc. Besides, the gesture manipulation function is implemented based on the touch input interface. Among these devices, tablet computers (e.g. iPad or Android pad) are well known and eye-catching products.

However, traditional multimedia players with touch input or gesture manipulation function mainly adopt a touch sensing method with singular touch point for triggering multimedia playing functions (e.g. pause, fast forward, fast backward, displaying video chapter information, etc) while the video is playing. For example, user may perform one click with one finger to show a function menu and perform another click with one finger to select the desired function from the function menu. In this way, users must pay attention to information showed on the function menu for choosing the correct function icon within the function menu.

Therefore, traditional touch input function or gesture manipulation function on the multimedia players is considered to be unfriendly and unnatural, and it may cause some burdens to users in learning how to manipulating the multimedia players.

### SUMMARY

In order to solve aforesaid problems, an embodiment of the disclosure discloses a gesture manipulation method based on a touch sensor with multi-touch capability and a multimedia player apparatus thereof. Some useful multimedia playing functions are bond to some specific gestures which are intuitive and corresponding to the multimedia playing functions, such that the gestures manipulating mechanics can be easy to understand. No extra effort is needed by users for learning how to manipulate the multimedia player apparatus. The manipulation efficiency can be evaluated. Users may focus on the displaying screen without distracting by some select lists.

Therefore, an aspect of the disclosure is to provide a gesture manipulation method suitable for a multimedia player apparatus with touch input function. The gesture manipulation method include steps of: detecting a gesture input while the multimedia player apparatus is playing a video file or a video stream; when the gesture input including X amount of finger contacts and the X amount of finger contacts relatively moving outwardly, executing a first display procedure on the multimedia player apparatus, wherein X is a positive integer greater than or equal to two; and, when the gesture input including Y amount of finger contacts and the Y amount of finger contacts relatively moving inwardly, executing a second display procedure on the multimedia player apparatus, wherein Y is a positive integer greater than or equal to two, the first display procedure is a detail display procedure and the second procedure is a summary display procedure, or the first display procedure is the summary display procedure and the second procedure is the detail display procedure.

According to an embodiment of the disclosure, the detail display procedure includes displaying detail information of the video file or the video stream. The summary display procedure includes displaying a playing content list, and the playing content list includes a plurality of playable video files or video streams on the multimedia player apparatus.

According to another embodiment of the disclosure, the gesture manipulation method further include a step of: when the gesture input including Z amount of finger contacts and the Z amount of finger contacts relatively moving inwardly, capturing a currently displaying screen of the video file or the video stream on the multimedia player apparatus, wherein Z is a positive integer greater than or equal to two, and Z is not equal to Y.

Another aspect of the disclosure is to provide a gesture manipulation method suitable for a multimedia player apparatus with touch input function. The gesture manipulation method comprising steps of: detecting a gesture input while the multimedia player apparatus is playing a video file or a video stream; and, when the gesture input including K amount of finger contacts and the K amount of finger contacts relatively rotating over time, executing a corresponding adjustment procedure on the multimedia player apparatus, the corresponding adjustment procedure comprising at least one adjustment selected from a playing speed adjustment, a fast forward adjustment, a fast backward adjustment, a volume adjustment and a display configuration adjustment, wherein K is a positive integer greater than or equal to two.

According to an embodiment of the disclosure, the display configuration adjustment includes adjusting at least one of a displaying brightness, a displaying contrast or a displaying color temperature.

According to another embodiment of the disclosure, the multimedia player apparatus executes the corresponding adjustment procedure according to at least one of a rotating direction, a rotating radian or a rotating speed among the K amount of finger contacts over time.

Another aspect of the disclosure is to provide a multimedia player apparatus. The multimedia player apparatus includes a displaying module, a touch input interface and a processing unit. The displaying module can be used for displaying a video file or a video stream. The touch input interface can be used for detecting a gesture input. The processing unit is electrically connected with the displaying module and the touch input interface.

According to an embodiment of the disclosure, when the gesture input includes X amount of finger contacts and the X amount of finger contacts relatively moving outwardly, the multimedia player apparatus executes a first display procedure, wherein X is a positive integer greater than or equal to two.

Besides, when the gesture input includes Y amount of finger contacts and the Y amount of finger contacts relatively moving inwardly, the multimedia player apparatus executes a second display procedure, wherein Y is a positive integer greater than or equal to two.

Besides, when the gesture input includes Z amount of finger contacts and the Z amount of finger contacts relatively moving inwardly, the multimedia player apparatus captures a currently displaying screen of the video file or the video stream, wherein Z is a positive integer greater than or equal to two, and Z is not equal to Y.

The first display procedure is a detail display procedure and the second procedure is a summary display procedure, or the first display procedure is the summary display procedure and the second procedure is the detail display procedure. The detail display procedure includes displaying detail information of the video file or the video stream. The summary display procedure includes displaying a playing content list. The playing content list includes a plurality of playable video files or video streams on the multimedia player apparatus.

According to another embodiment of the disclosure, when the gesture input includes K amount of finger contacts and the K amount of finger contacts relatively rotating over time, the multimedia player apparatus executes a corresponding adjustment procedure. The corresponding adjustment procedure includes at least one adjustment selected from a playing speed adjustment, a fast forward adjustment, a fast backward adjustment, a volume adjustment and a display configuration adjustment. The display configuration adjustment includes adjusting at least one of a displaying brightness, a displaying contrast or a displaying color temperature. The multimedia player apparatus executes the corresponding adjustment procedure according to at least one of a rotating direction, a rotating radian or a rotating speed among the K amount of finger contacts over time, wherein K is a positive integer greater than or equal to two.

### BRIEF DESCRIPTION OF THE DRAWINGS

The invention can be more fully understood by reading the following detailed description of the embodiments, with reference made to the accompanying drawings as follows:

FIG. 1 is a function block diagram illustrating a multimedia player apparatus according to an embodiment of the disclosure;

FIG. 2 is a flow chart illustrating a gesture manipulation method according to an embodiment of the disclosure;

FIG. 3A is a schematic diagram illustrating that the gesture input includes two finger contacts relatively moving outwardly over time;

FIG. 3B is a schematic diagram illustrating that the multimedia player apparatus performs a detail display procedure;

FIG. 4A is a schematic diagram illustrating that the gesture input includes two finger contacts relatively moving inwardly over time;

FIG. 4B is a schematic diagram illustrating that the multimedia player apparatus performs a summary display procedure;

FIG. 5 is a schematic diagram illustrating that the gesture input includes three finger contacts relatively moving inwardly over time; and

FIG. 6 is a schematic diagram illustrating that the gesture input includes two finger contacts rotating over time.

### DETAILED DESCRIPTION

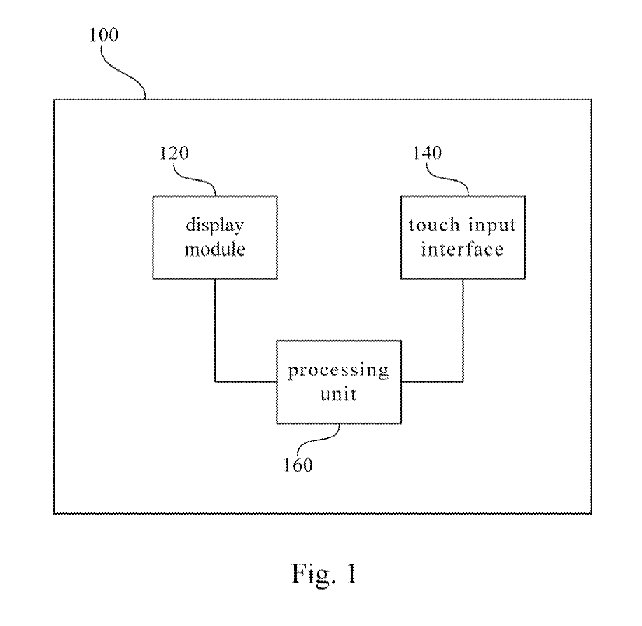

Please refer to FIG. 1, which is a function block diagram illustrating a multimedia player apparatus 100 according to an embodiment of the disclosure. As shown in FIG. 1, the multimedia player apparatus 100 includes a display module 120, a touch input interface 140 and a processing unit 160.

The displaying module 120 can be used for displaying a video file or a video stream. The touch input interface 140 can be used for detecting a gesture input with multi-touch capability. In other words, the touch input interface 140 may detect a plurality of finger contacts at once. Accordingly, the touch input interface 140 may figure out the total amount of the finger contacts and location coordinates of each finger contacts, so as to form a gesture input corresponding to multiple fingers.

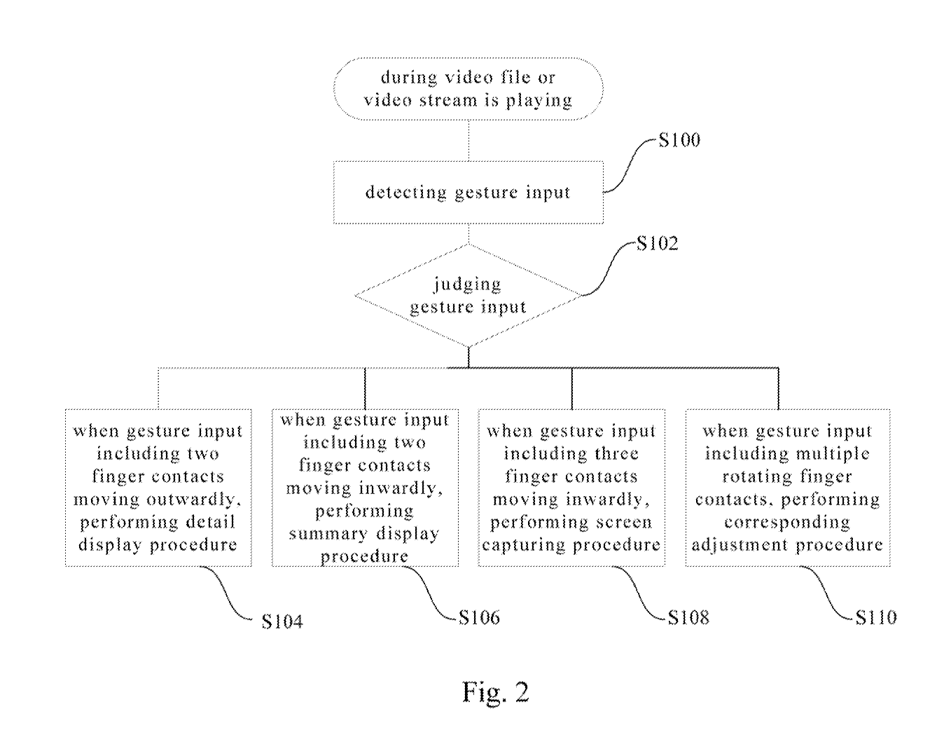

The processing unit 160 is electrically connected with the displaying module 120 and the touch input interface 140. The processing unit 160 may judge based on the gesture input generated by the touch input interface 140, and execute corresponding procedures or software programs, so as to switch or vary the content or displaying configuration on the display module 120. In the embodiment, the multimedia player apparatus 100 with touch input function may perform a gesture manipulation method for judging the gesture input and performing follow-up applications. Please refer to FIG. 2, which is a flow chart illustrating a gesture manipulation method according to an embodiment of the disclosure.

As shown in FIG. 2, while the multimedia player apparatus 100 is playing a video file or a video stream, the gesture manipulation method of the embodiment may perform step S100 for detecting the gesture input at first. Afterward, step S102 is performed for judging the content of the gesture input, such as total amount of the finger contacts involved in the gesture input, and exact coordinates of the finger contacts or location relativity among the finger contacts.

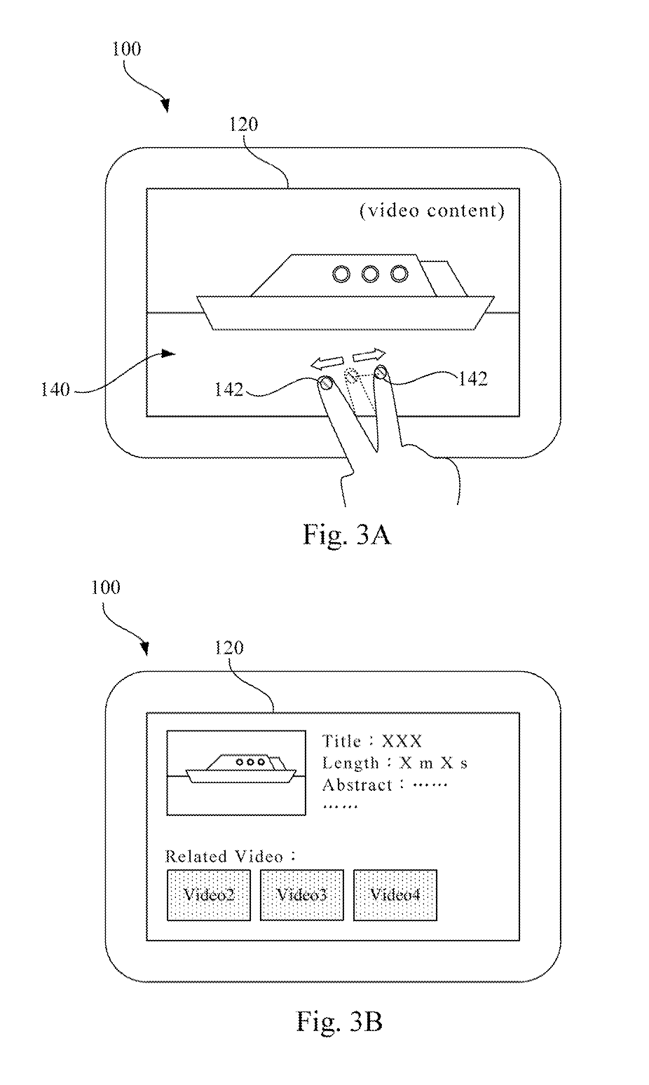

Please also refer to FIG. 3A and FIG. 3B. FIG. 3A is a schematic diagram illustrating that the gesture input includes two finger contacts 142 relatively moving outwardly over time. FIG. 38 is a schematic diagram illustrating that the multimedia player apparatus 100 performs a detail display procedure.

In the embodiment shown in FIG. 3A, during the video file or the video stream is playing, when the gesture input is detected to include two finger contacts 142 and these two finger contacts 142 move outwardly over time, the gesture input can be judged to be related to a first display manipulation by the processing unit 160. Then, the multimedia player apparatus 100 may launch a first display procedure. In this embodiment, the first display procedure is the detail display procedure. The gesture manipulation method of the embodiment may perform step S104 for executing the detail display procedure, so as to show the detail information (e.g. video title, video length, video abstract, other related video, or other related information) of currently playing video file or video stream on the display module 120, as shown in FIG. 3B.

In the embodiment, the detail display procedure is launched when the gesture input includes two finger contacts 142 and these two finger contacts 142 move outwardly over time. However, the detail display procedure is not limited to be corresponding to the gesture input including two finger contacts. In other embodiments, the detail display procedure is configured to be launched by the multimedia player apparatus 100 when the gesture input includes X amount of finger contacts (X is a positive integer greater than or equal to two) and the X amount of finger contacts move outwardly over time.

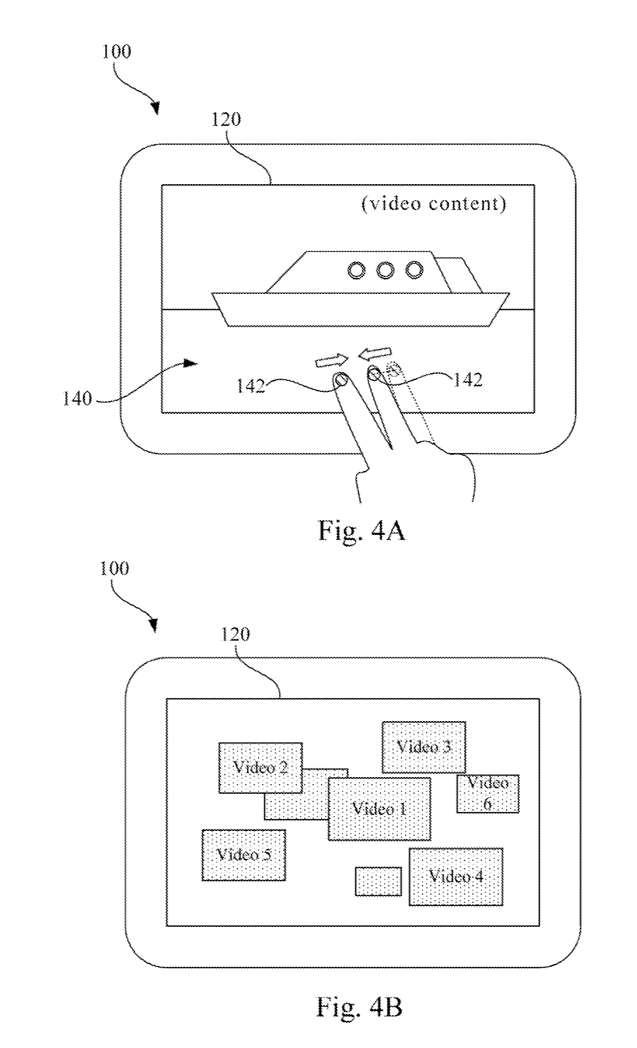

On the other hand, please also refer to FIG. 4A and FIG. 4B. FIG. 4A is a schematic diagram illustrating that the gesture input includes two finger contacts 142 relatively moving inwardly over time. FIG. 4B is a schematic diagram illustrating that the multimedia player apparatus 100 performs a summary display procedure.

In the embodiment shown in FIG. 4A, during the video file or the video stream is playing, when the gesture input is detected to include two finger contacts 142 and these two finger contacts 142 move inwardly over time, the gesture input can be judged to be related to a second display manipulation by the processing unit 160. Then, the multimedia player apparatus 100 may launch a second display procedure. In this embodiment, the second display procedure is the summary display procedure. The gesture manipulation method of the embodiment may perform step S106 for executing the summary display procedure, so as to show a playing content list on the display module 120. The playing content list may include a plurality of playable video files or video streams on the multimedia player apparatus 100, as shown in FIG. 4B.

In the embodiment, the summary display procedure is launched when the gesture input includes two finger contacts 142 and these two finger contacts 142 move inwardly over time. However, the summary display procedure is not limited to be corresponding to the gesture input including two finger contacts. In other embodiments, the summary display procedure is configured to be launched by the multimedia player apparatus 100 when the gesture input includes Y amount of finger contacts (Y is a positive integer greater than or to equal to two) and the Y amount of finger contacts move inwardly over time. Besides, the summary display procedure and the detail display procedure can be corresponding to the gesture inputs with the same amount of finger contacts (e.g. both adopting two finger contacts), or with different amounts of finger contacts in some other embodiments.

As mentioned in aforesaid embodiment, two finger contacts moving outwardly over time is determined to be the first display manipulation, so as to launch the first display procedure (detail display procedure); besides, two finger contacts moving inwardly over time is determined to be the second display manipulation, so as to launch the second display procedure (summary display procedure). However, the disclosure is not limited to this.

In another embodiment, the function of the first display procedure and the second display procedure can be switched. In other words, the first display procedure corresponding to outward finger movement can be the summary display procedure; and the second display procedure corresponding to inward finger movement can be the detail display procedure.

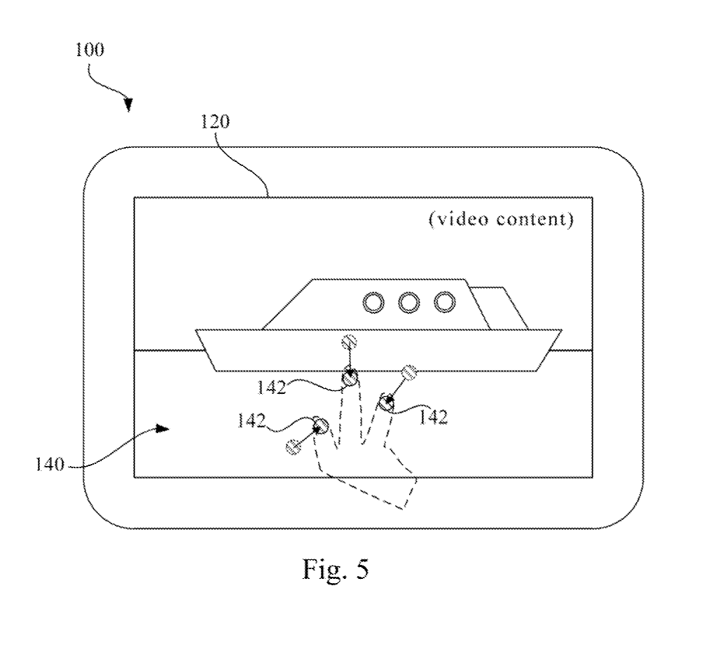

On the other hand, please refer to FIG. 5. FIG. 5 is a schematic diagram illustrating that the gesture input includes three finger contacts 142 relatively moving inwardly over time.

In the embodiment shown in FIG. 5, during the video file or the video stream is playing, when the gesture input is detected to include three finger contacts 142 and these three finger contacts 142 move inwardly over time, the gesture input can be judged to be related to a screen capturing manipulation by the processing unit 160. Then, the multimedia player apparatus 100 may launch a screen capturing procedure. The gesture manipulation method of the embodiment may perform step S108 for executing the screen capturing procedure, so as to capture a currently displaying screen of the video file or the video stream.

In the embodiment, the screen capturing procedure is launched when the gesture input includes three finger contacts 142 and these three finger contacts 142 move inwardly over time. However, the screen capturing procedure is not limited to be corresponding to the gesture input including three finger contacts. In other embodiments, the screen capturing procedure is configured to be launched by the multimedia player apparatus 100 when the gesture input includes Z amount of finger contacts (Z is a positive integer greater than or equal to two) and the Z amount of finger contacts move inwardly over time. Besides, in order to prevent confusion between the screen capturing procedure and aforesaid summary display procedure, the Z amount corresponding to the screen capturing procedure is different from the Y amount corresponding to the summary display procedure.

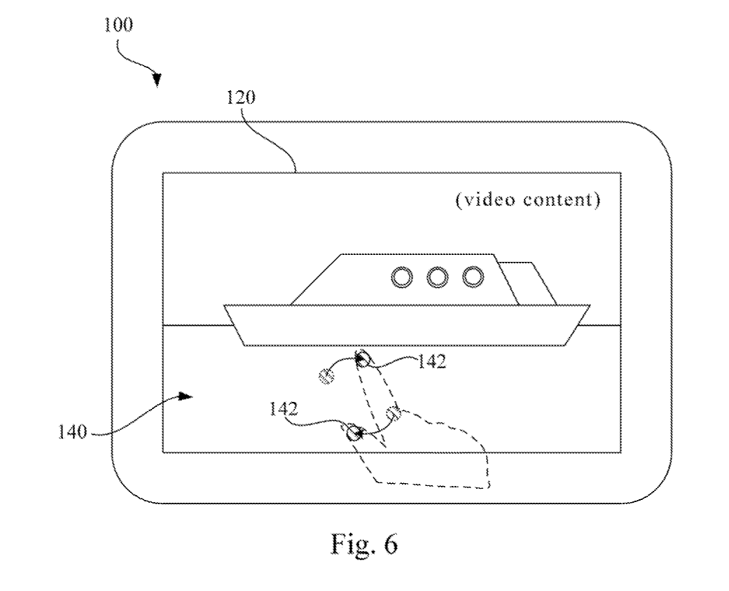

In aforesaid embodiment of this disclosure, gesture manipulation with outward stretching or inward clamping movement is disclosed, but the disclosure is not limited to this. Please also refer to FIG. 6. FIG. 6 is a schematic diagram illustrating that the gesture input includes two finger contacts 142 rotating over time.

In the embodiment shown in FIG. 6, during the video file or the video stream is playing, when the gesture input is detected to include two finger contacts 142 and these two finger contacts 142 rotating over time, the gesture input can be judged to be related to a rotary knob manipulation by the processing unit 160. The gesture manipulation method of the embodiment may perform step S110 for executing a corresponding adjusting procedure.

In this embodiment, the adjustment procedure corresponding to the rotary knob manipulation includes at least one of a playing speed adjustment (e.g. 1.5 times the origin speed, 2 times the origin speed, or 4 times the origin speed) of the video file or the video stream, a fast forward adjustment, a fast backward adjustment, a volume adjustment and a display configuration adjustment. The display configuration adjustment may include adjusting at least one of a displaying brightness, a displaying contrast or a displaying color temperature.

Take a practical application for example, when the rotating direction of the gesture input is clockwise, the fast forward adjustment is executed; and when the rotating direction of the gesture input is counter-clockwise, the fast backward adjustment is executed. Furthermore, the multiplying index of the fast forward/fast backward adjustment can be based on a rotating radian or a rotating speed of the gesture input. However, the disclosure is not limited to this.

In the embodiment, the corresponding adjusting procedure is launched when the gesture input includes two finger contacts 142 and these two finger contacts 142 rotate over time. However, the corresponding adjusting procedure is not limited to be corresponding to the gesture input including two finger contacts. In other embodiments, the corresponding adjusting procedure is configured to be launched by the multimedia player apparatus 100 when the gesture input includes K amount of finger contacts (K is a positive integer greater than or equal to two) and the K amount of finger contacts rotate over time. Besides, different type of adjustment can be performed according to different amount of finger contacts (e.g. two fingers, three fingers, four or more fingers).

This disclosure introduces a gesture manipulation method based on a touch sensor with multi-touch capability and a multimedia player apparatus thereof. Some useful multimedia playing functions are bond to some specific gestures (stretching, clamping, rotating, etc) which are intuitive and corresponding to the multimedia playing functions (detail displaying, summary displaying, configuration adjustment, etc), such that the gestures manipulating mechanics can be easy to understand. No extra effort is needed by users for learning how to manipulate the multimedia player apparatus. The manipulation efficiency can be evaluated. Users may focus on the displaying screen without distracting by some select lists.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the disclosure. In view of the foregoing, it is intended that the present invention cover modifications and variations of this invention provided they fall within the scope of the following claims.

What is claimed is:

1. A gesture manipulation method, suitable for a multimedia player apparatus with touch input function, the gesture manipulation method comprising steps of:
detecting a gesture input while the multimedia player apparatus is playing a video file or a video stream;
when the gesture input including X amount of finger contacts and the X amount of finger contacts relatively moving outwardly, executing a first display procedure on the multimedia player apparatus, wherein X is a positive integer greater than or equal to two; and
when the gesture input including Y amount of finger contacts and the Y amount of finger contacts relatively moving inwardly, executing a second display procedure on the multimedia player apparatus, wherein Y is a positive integer greater than or equal to two, the first display procedure is a detail display procedure and the second procedure is a summary display procedure, or the first display procedure is the summary display procedure and the second procedure is the detail display procedure.

2. The gesture manipulation method of claim 1, wherein the detail display procedure comprises displaying detail information of the video file or the video stream, the summary display procedure comprises displaying a playing content list, and the playing content list comprises a plurality of playable video files or video streams on the multimedia player apparatus.

3. The gesture manipulation method of claim 1, further comprising a step of:
when the gesture input including Z amount of finger contacts and the Z amount of finger contacts relatively moving inwardly, capturing a currently displaying screen of the video file or the video stream on the multimedia player apparatus, wherein Z is a positive integer greater than or equal to two, and Z is not equal to Y.

4. A gesture manipulation method, suitable for a multimedia player in apparatus with touch input function, the gesture manipulation method comprising steps of:
detecting a gesture input while the multimedia player apparatus is playing a video file or a video stream; and
when the gesture input including K amount of finger contacts and the K amount of finger contacts relatively rotating over time, executing a corresponding adjustment procedure on the multimedia player apparatus, the corresponding adjustment procedure comprising at least one adjustment selected from a playing speed adjustment, a fast forward adjustment, a fast backward adjustment, a volume adjustment and a display configuration adjustment, wherein K is a positive integer greater than or equal to two.

5. The gesture manipulation method of claim 4, wherein the display configuration adjustment comprises adjusting at least one of a displaying brightness, a displaying contrast or a displaying color temperature.

6. The gesture manipulation method of claim 4, wherein the multimedia player apparatus executes the corresponding adjustment procedure according to at least one of a rotating direction, a rotating radian or a rotating speed among the K amount of finger contacts over time.

7. A multimedia player apparatus, comprising:
a displaying module for displaying a video file or a video stream;
a touch input interface for detecting a gesture input; and
a processing unit electrically connected with the displaying module and the touch input interface, when the gesture input including X amount of finger contacts and the X amount of finger contacts relatively moving outwardly, executing a first display procedure on the multimedia player apparatus, wherein X is a positive integer greater than or equal to two, besides, when the gesture input including Y amount of finger contacts and the Y amount of finger contacts relatively moving inwardly, executing a second display procedure on the multimedia player apparatus, wherein Y is a positive integer greater than or equal to two, besides, when the gesture input including Z amount of finger contacts and the Z amount of finger contacts relatively moving inwardly, capturing a currently displaying screen of the video file or the video stream on the multimedia player apparatus, wherein Z is a positive integer greater than or equal to two, and Z is not equal to Y, wherein the first display procedure is a detail display procedure and the second procedure is a summary display procedure, or the first display procedure is the summary display procedure and the second procedure is the detail display procedure, the detail display procedure comprises displaying detail information of the video file or the video stream, the summary display procedure comprises displaying a playing content list, and the playing content list comprises a plurality of playable video files or video streams on the multimedia player apparatus.

8. A multimedia player apparatus, comprising:
a displaying module for displaying a video file or a video stream;
a touch input interface for detecting a gesture input; and
a processing unit electrically connected with the displaying module and to the touch input interface, when the gesture input including K amount of finger contacts and the K amount of finger contacts relatively rotating over time, executing a corresponding adjustment procedure on the multimedia player apparatus, the corresponding adjustment procedure comprising at least one adjustment selected from a playing speed adjustment, a fast forward adjustment, a fast backward adjustment, a volume adjustment and a display configuration adjustment, wherein the display configuration adjustment comprises adjusting at least one of a displaying brightness, a displaying contrast or a displaying color temperature, and the multimedia player apparatus executes the corresponding adjustment procedure according to at least one of a rotating direction, a rotating radian or a rotating speed among the K amount of finger contacts over time, and K is a positive integer greater than or equal to two.
